(19) United States
(12) Patent Application Publication
(10) Pub. No.: US 2017/0023247 A1
(43) Pub. Date: Jan. 26, 2017

(54) SYSTEM AND METHOD FOR TREATING WASTE PARTICULATE SOLIDS

(71) Applicants: Robert Mark GROSS, Piney (CA); ECO-ROCKS RECYCLING SOLUTIONS INC., Calgary (CA); IRONCREEK OILFIELD RENTALS INC., Cochrane (CA)

(72) Inventors: Robert Mark GROSS, Piney (CA); Kim CARON, Cochrane (CA)

(73) Assignees: ECO-ROCKS RECYCLING SOLUTIONS INC., Calgary (CA); IRONCREEK OILFIELD RENTALS INC., Cochrane (CA)

(21) Appl. No.: 15/190,001

(22) Filed: Jun. 22, 2016

Related U.S. Application Data
(60) Provisional application No. 62/182,733, filed on Jun. 22, 2015.

(51) Int. Cl. F23G 7/05; B08B 7/00

(52) U.S. Cl. CPC F23G 7/05; B08B 7/0071; F23G 2209/00; F23G 2205/00

(57) ABSTRACT

A system for combusting particulate solids comprises a hopper, a furnace and a secondary afterburner. The furnace further comprises at least one exothermic continuous reaction vessel (ECRV) that has a volume that is significantly smaller than the volume of the furnace, which operates at a temperature that is higher than the temperature in the remainder of the furnace, the temperature being high enough to auto-ignite the particulates when they enter the ECRV. The ECRV rotates in unison with a conveyor that delivers the solid particulates from a hopper. The apparatus is energy efficient, with few working parts, and provides combusted particulate solids that can be disposed of directly without environmental concerns.

### FIELD

Embodiments disclosed herein generally relate to a system and method for treating particulate solids, such as drill cuttings. More particularly, described herein is a system and method for removing contaminants from particulate solids so that the solids can be disposed without environmental damage.

### BACKGROUND

In drilling operations, e.g., for gas or oil, it is conventional practice to supply the drill bit with a mud lubricant which both cools and lubricates the bit and carries to the surface the drilling cuttings. The mud is separated from the cuttings and the mud is recycled. The drill cuttings are disposed to waste.

Drilling through rock generally requires the use of some type of fluid to clear cuttings from the bore hole formed by the drill. In some applications, the drilling fluid can be as simple as compressed air. However, when drilling is conducted to tap fossil fuel resources, the drilling fluid used is usually a “drilling mud.” Drilling muds are generally placed in three categories, depending on the major fluid component: water-based, oil-based, and pneumatic. In the oil and gas industry, oil-based muds predominate.

Oil-based muds serve several functions during drilling: removing cuttings from the well, suspending the cuttings, controlling formation pressure, sealing permeable formations, stabilizing the wellbore, reducing formation damage, cooling the drill, lubricating the drill, transmitting hydraulic energy to tools and the bit, and reducing corrosion. Oil-based drilling muds typically comprise a hydrocarbon-water emulsion, an emulsifier, and clay. Bentonite is the most widely used clay in drilling muds, although other clays can be used. Other ingredients are often present. Barite, for example, is often used as a weighting agent to increase the outward hydrostatic pressure in the borehole.

Typically, used drilling mud will be recirculated through a drill and borehole at the drill site. The larger cuttings are removed from the mud prior to recirculation. This is generally achieved by running the used mud over a shaker screen. This collects the drill cuttings which were mixed with drilling mud and groundwater. The waste drilling mud and the cuttings are then subject to disposal, either with or without some form of treatment. In some situations unused drilling mud must be disposed of, for example if a mud is stored for too long, and loses some of its beneficial properties. All such muds, used or unused, are referred to in this disclosure as “waste drilling mud.”

Disposal of waste drilling muds, particularly oil-based drilling muds, is a major problem in the art. Diesel is commonly used as the oil in drilling muds, and formation oil may also be present regardless of the type of drilling mud used. Diesel poses environmental hazards, so diesel-based mud must be deposited in special landfills constructed with an impermeable lining. This is expensive, and the possibility remains that the hazardous components of the mud could leak from the landfill, damaging the environment and exposing all parties involved to toxic cleanup liability. Used drilling muds may also contain groundwater with high salt concentrations. Such saline water can also be environmentally harmful if not disposed of properly; its disposal is similarly expensive and can constitute a continuing threat to the environment with attendant legal liabilities. The task of disposal of drilling muds is complicated by the complex, multi-phase nature of the muds, which makes it difficult to isolate the hazardous components to reduce disposal volumes.

Even when the bulk oil fraction of a drilling mud is separated and purified, residual organic compounds often remain tightly associated with solids in the mud either on their surfaces or within their porous structures, (either the clay or drill cuttings), requiring disposal as a hazardous substance. Methods for completely removing hydrocarbons from the solid phase (cutting solids and other residual solids in the drilling mud), such as steam distillation, are energy-intensive and inefficient. Solvent-based methods of hydrocarbon separation from the solid phase merely compound the problem by the introduction of hazardous solvent. Combustion of the liquid hydrocarbon in emulsion requires very high operating temperatures and can be a source of air pollution. Combustion of liquid hydrocarbon when mixed with the solid phase is problematic, as it requires the facility be licensed as an incinerator.

It is essential to have economic means for cleaning contaminated drill cutting solids and other solid particulates sufficiently to enable disposal in an environmentally-acceptable manner. It is particularly desirable to have a means for cleaning oil contaminated drill cuttings which is energy efficient, does not require the addition of chemicals, is relatively compact, and provides residual material that can be disposed of directly into the environment.

### SUMMARY

Disclosed herein is a system for treating solid particulates, which comprises a hopper that feeds the solid particulates into at least one rotating exothermic continuous reaction vessel (ECRV) disposed in a furnace, and a secondary afterburner for treating an exhaust from the treatment of the solid particulates in the rotating ECRV.

Described herein is a method for treating solid particulates, such as for example drill cuttings having diesel based drilling mud, which comprises blending the particulates with an anti-agglomeration material, combusting the particulates for forming treated particulates and an exhaust, removing the treated particulates, combusting the exhaust in a secondary afterburner and expelling the gaseous products of combustion of the exhaust into the atmosphere.

In one aspect, described herein is a system for combusting particulate solids comprising:
a) a hopper, a furnace and a secondary afterburner;
b) said furnace further comprising at least one exothermic continuous reaction vessel (ECRV), said ECRV having a volume that is smaller than the volume of the furnace, and said ECRV further having a receiving end and a disposal end within the furnace;
c) at least one conduit extending from the hopper to the receiving end of the at least one ECRV, and
d) a rotating conveyor inside the at least one conduit, for conveying the particulate solids from the hopper into the ECRV,
e) said rotating conveyor being connected to the at least one ECRV, such that the ECRV will rotate with the rotating conveyor.

In one embodiment, the disposal end of the ECRV is above an opening in the furnace through which particulate solids can be removed from the furnace.

In one embodiment, the rotating conveyor is a screw type conveyor.

In one embodiment, the ECRV is a hollow cylinder.

In one embodiment, the ECRV is comprised of high temperature steel.

In one embodiment, the axis of rotation of the ECRV aligns with the axis of rotation of the conveyor.

In one embodiment, the system further comprises an opening between the furnace and the secondary afterburner through which exhaust exiting the disposal end of the ECRV can enter the secondary afterburner.

In one embodiment, the rotation of the rotating conveyor drives the rotation of the ECRV.

In one embodiment, the volume of the ECRV is less than about 25% of the volume of the furnace.

In one embodiment, the system further comprises a heater that heats the at least one ECRV.

In another aspect, described herein is a method of combusting solid particulates comprising:

a) delivering the solid particulates from a hopper to a rotating exothermic continuous reaction vessel (ECRV) inside a furnace, said ECRV having a volume that is substantially less than the volume of the furnace;
b) combusting the solid particulates within the ECRV while the ECRV is rotating at the auto-ignition temperature of the solid particulates.
c) expelling the solid particulates from the ECRV into the furnace; and
d) collecting the solid particulates from the furnace.

In one embodiment, the method further comprises heating the ECRV to the auto-ignition temperature before delivering the solid particulates from the hopper to the rotating ECRV. In one embodiment the volume of the ECRV is less than about 25% of the volume of the furnace.

In one embodiment, the method further comprises delivering the solid particulates from the hopper to the ECRV with a screw type conveyor which removes the solid particulates from the hopper and delivers them along a conduit towards the ECRV.

In one embodiment of the method, the rotation of the screw type conveyor drives the rotation of the ECRV.

In one embodiment of the method, the axis of rotation of the ECRV aligns with the axis of rotation of the conveyor.

In one embodiment, the method further comprises combusting an exhaust from the ECRV in a secondary afterburner.

### BRIEF DESCRIPTION OF THE DRAWINGS

FIG. 1 is a side perspective view of an embodiment of the invention, illustrating a system having a hopper, a furnace and a secondary afterburner, disposed on a skid;

FIG. 2 is a side perspective view of the embodiment of FIG. 1, illustrating a housing around the furnace and secondary afterburner, and with one side wall around the bottom of the hopper removed;

FIG. 3 is a side perspective view of the embodiment of FIG. 1, with the skid, top cover and lower hopper walls removed;

FIG. 4 is a side perspective view of the hopper of FIG. 3, illustrating a bin supported on legs, and conduits which encompass screw conveyors extending from one end of the hopper;

FIG. 5 is a cross sectional perspective view of the embodiment of FIG. 4 to reveal the screw type conveyors at the bottom of the hopper;

FIG. 6 is a side perspective view of the combustor of FIG. 1, illustrating a furnace, a secondary afterburner, and an exhaust stack, and with the hopper removed;

FIG. 7 is a side cross-sectional view through the furnace and secondary afterburner of FIG. 6, illustrating an exothermic continuous reaction vessel disposed in the furnace;

FIG. 8 is a side perspective view of the embodiment of FIG. 6, sectioned through the front end of the furnace and secondary afterburner, illustrating two exothermic continuous reaction vessels inside the furnace;

FIG. 9A is a side perspective view of the arrangement of two lower screw type conveyors of a hopper, and two exothermic continuous reaction vessels of a furnace, showing the front wall 132 of the furnace and the bracket 134 attached to the endwall of the hopper, for context;

FIG. 9B is a cross section along line A-A of FIG. 9A, to show one of the screw type conveyors extending through to a feed end of one exothermic continuous reaction vessel;

FIG. 9C is an exploded view of the connection between the shaft of the screw type conveyor and the shaft of the exothermic continuous reaction vessel; and

FIG. 9D is a perspective view inside one exothermic continuous reaction vessel showing a shaft connected to a plurality of spokes which are in turn connected to the drum of the exothermic continuous reaction vessel.

### DETAILED DESCRIPTION

Described herein is a system for continuously removing contaminants from particulate solids, and a corresponding method and apparatus therefor. The method and apparatus have particular application to removing contaminants from particulate solids such as oil from drill cutting solids, so that the solids can be safely disposed without concern that they will harm the environment. “Drill cuttings” or “cuttings” as used herein includes all solids that may be separated from the drilling mud returned from a wellbore during drilling operations. Although the majority of these solids comprise the actual borehole material cut from the formation, other solids materials will also usually be present, including additives which are conventionally used in formulating drilling muds such as weighting agents (e.g., barite, hematite), fluid loss materials (e.g., miscellaneous fibrous materials) and other well-known additives. The actual borehole material contained in the solids will generally comprise a wide spectrum of sizes ranging from extremely fine particles to relative coarse particles and the relative proportions will vary extensively with the types of formations being drilled.

While the method and apparatus are described herein with reference to drill cutting solids, it is to be understood that the method and apparatus can be used to remove contaminants from a number of other inert particulate solids, such as: contaminated soils and mixed landfill wastes. In addition to removing contaminants from inert particulate solids, the method and apparatus can also be used to combust non-inert particulate solids, such as such as synthetic textiles such as mattress covers, poly-cotton fabrics, discarded carpet and household garbage.

The apparatus and method for treating drill cuttings comprises the steps of:
a) transferring drill cuttings that have been blended with an anti-agglomerating material (“blended drill cuttings”) to a hopper,
b) using at least one screw type conveyor in the hopper to both deliver the blended drill cuttings to at least one exothermic continuous reaction vessel (“ECRV”) inside a furnace, and to rotate the at least one ECRV inside the furnace;
c) combusting the blended drill cuttings inside the at least one ECRV to remove contaminants, such as hydrocarbons and the anti-agglomerating material, from the cuttings;
d) collecting the drill cuttings as they exit the at least one ECRV, and removing them from the furnace;
e) collecting the exhaust from the combustion of the blended drill cuttings, and delivering the exhaust to a secondary afterburner for supplemental combustion, such as for example with propane or natural gas.

The exhaust may be introduced into the round chamber of the secondary afterburner at an offset, thus induce the exhaust into a vortex spiral. The vortex spiral increases the residence time of the exhaust in the secondary afterburner, thus improving combustion of the exhaust.

Embodiments of the method do not require blending of the solids particulates with an anti-agglomerating material. One purpose of an anti-agglomerating material is to provide combustible material for solid particulates that cannot support their own combustion within the ECRV. Thus for example, for drill cuttings sawdust or small chips may be used to prevent agglomeration, but also to provide fuel for combustion. This may not be needed for solid particulates that are sufficiently combustible on their own, and that otherwise do not need an anti-agglomerating material to prevent agglomeration. Another purpose of an anti-agglomerating material may be to soak up excess fluid in solid particulates that have too much fluid.

The at least one exothermic reaction vessel, or ECRV, disposed inside the body of the furnace rotates continuously, keeping the solid particulates in constant motion, thus preventing agglomeration and maximizing removal of the contaminants by exposing surfaces of the particulates to oxygen for combustion. The rotation of the ECRV is driven by the screw type conveyor which extends from the hopper.

The feed end of the at least one ECRV, that is, the end which receives the solid particulates from the hopper may be level with, higher or lower than the discharge end of the ECRV. Thus, the feed end may be slightly higher than the discharge end, so that the ECRV is on a slight decline which may aid in the increasing the rate of movement of the particulate solids along the ECRV. Alternatively, the feed end may be slightly lower than the discharge end, so that the ECRV is on a slight incline from the feed end to the discharge end, which may aid in the retention of the particulate solids within the ECRV for a longer period of time.

The at least one ECRV is inside the furnace, but has a smaller volume than the volume of the furnace. The combustion of the solid particulates within the smaller volume of the ECRV results in a higher temperature within the ECRV than is obtained in the rest of the furnace. Thus, the entire furnace does not need to be brought up to the higher temperature of combustion to achieve combustion at this higher temperature, saving on input energy costs. Further, because of the high temperatures in the ECRV, the solid particulates may self-ignite upon entry. Thus, after an initial start-up, the combustion reaction is self-sustaining and no longer needs the input of energy, except perhaps occasionally. Because combustion occurs at a higher temperature in a smaller volume, efficiency is therefore improved as compared to conventional furnaces.

The internal volume (capacity) of the ECRV is determined by a number of factors, including: the type of particulates to be combusted, the auto-ignition temperature of the particulates to be combusted, the feed rate of the particulates into the ECRV and the residence time of the particulates within the ECRV, for example. The internal volume of the ECRV is selected so that, given these and other factors, the particulate auto-ignites within it. In embodiments, the internal volume of the ECRV is preferably less than about 25% of the internal volume of the furnace 130. In embodiments the internal volume of the ECRV is between about 5% to about 25%, between about 5% to about 20%, between about 10% to about 20%, between about 5% to about 15%, between about 10% to about 15% or between about 5% to about 10% of the internal volume of the furnace. In other embodiments the internal volume of the ECRV is about 5%, 10%, 15%, 20% or 25% of the internal volume of the furnace.

Having thus described the basic apparatus and method herein, specific embodiments will now be described, as shown in the accompanying Figures.

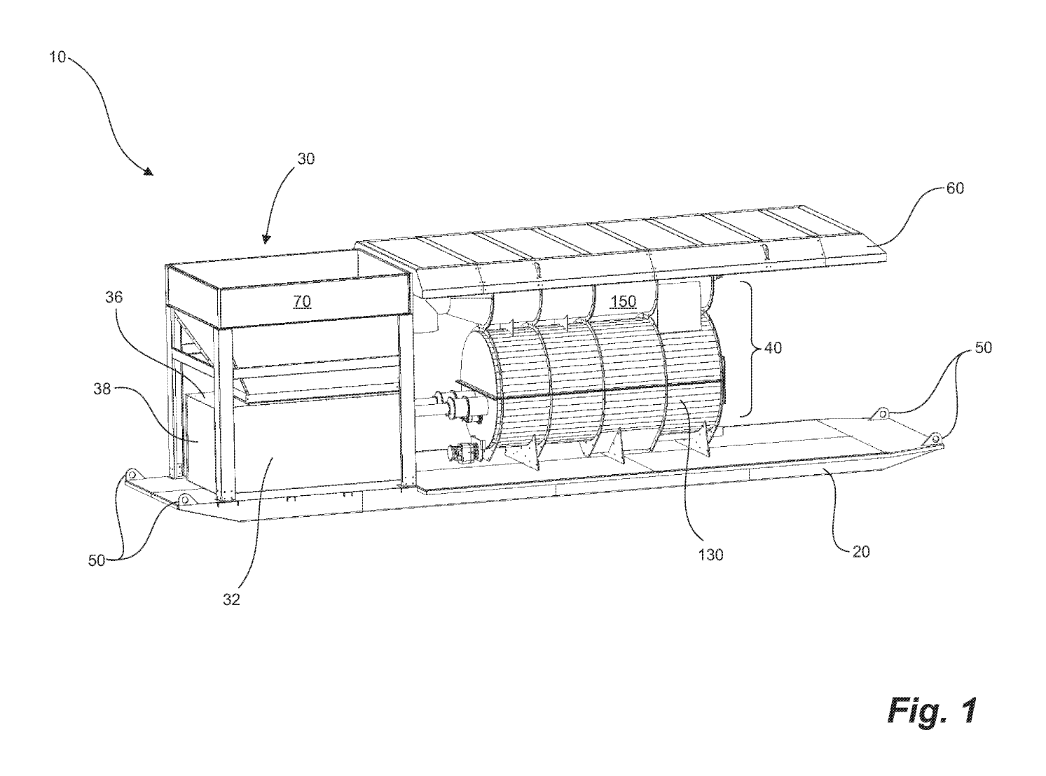

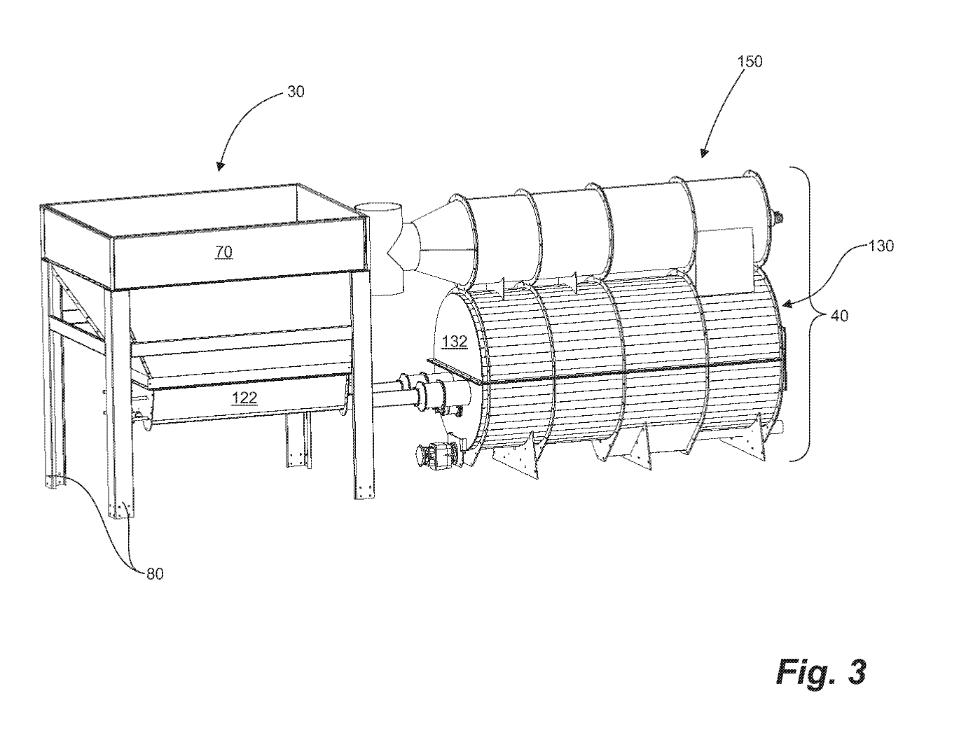

With reference to FIGS. 1 and 3, an embodiment of a system 10 for treating drill cuttings from shale and/or cardium sandstone comprises a hopper 30 and a combustor 40, the combustor further comprising a furnace 130 and a secondary afterburner 150. The system may further be disposed on a skid 20, which enables the system 10 to be transported from one operational site to another relatively easily, having eyelets 50 for connecting the skid 20 to cables for dragging it along the ground or for winching it onto a transport truck (not shown).

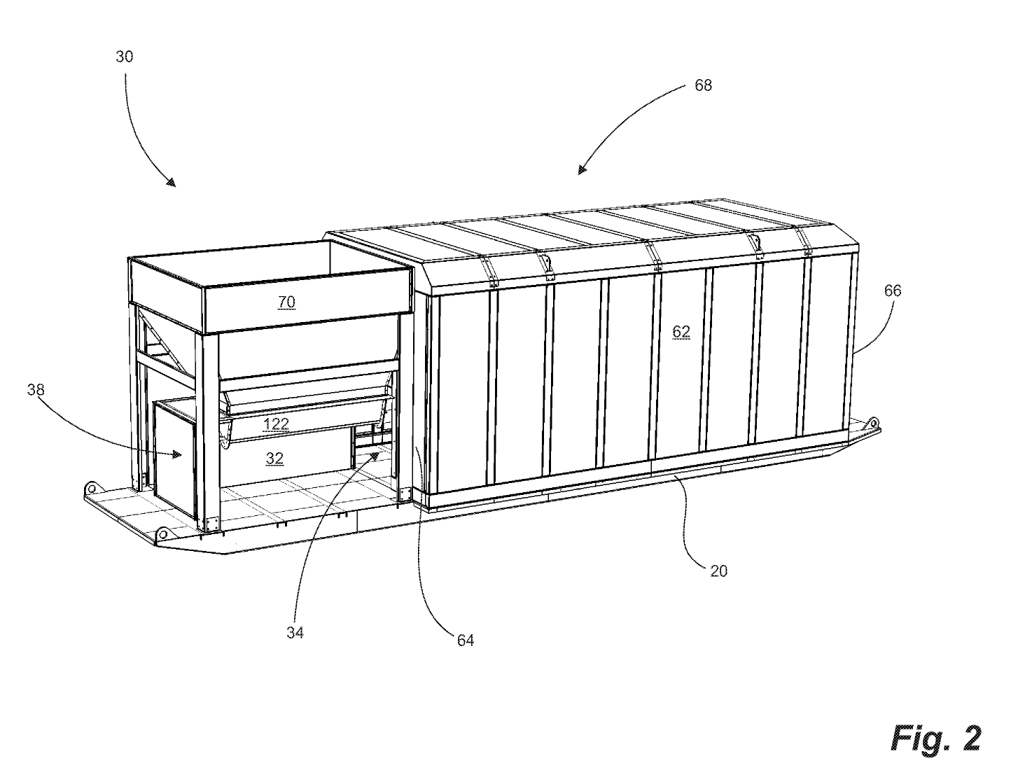

In one embodiment, as shown in FIG. 2, the system 10 may further comprise a top 60, side walls 62, 62, a front wall 64 and an end wall 66, which form a housing 68 around the system 10. The top, sides front and end walls may be double-paneled, e.g., made of double-walled steel, to retain heat from the furnace 130 and secondary afterburner 150 therein, and to allow for insulation to be inserted between the panels, if desired.

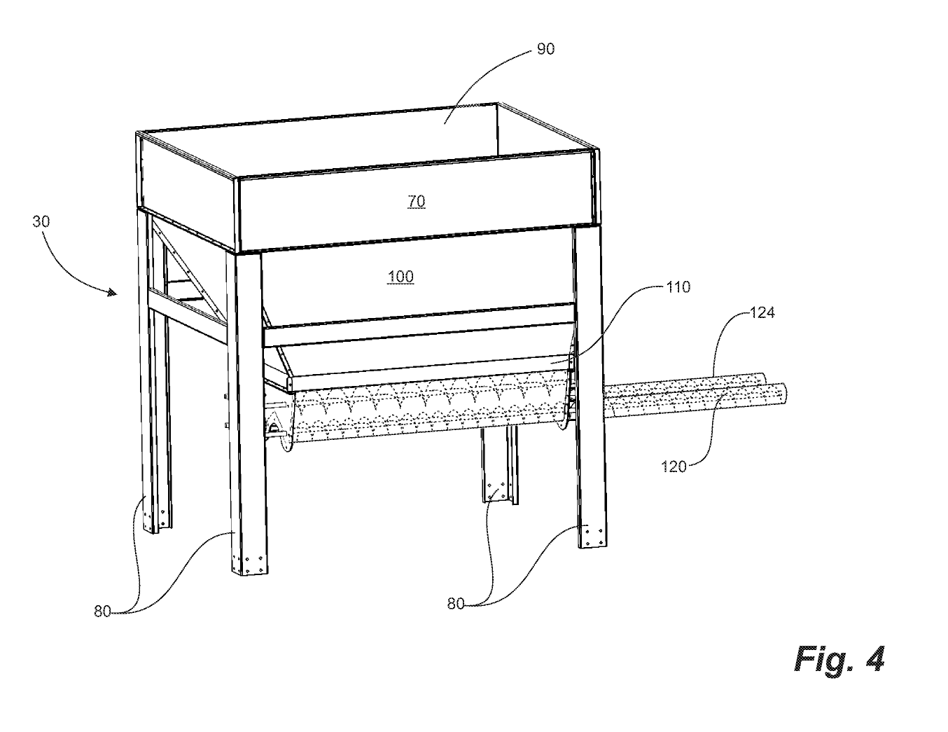

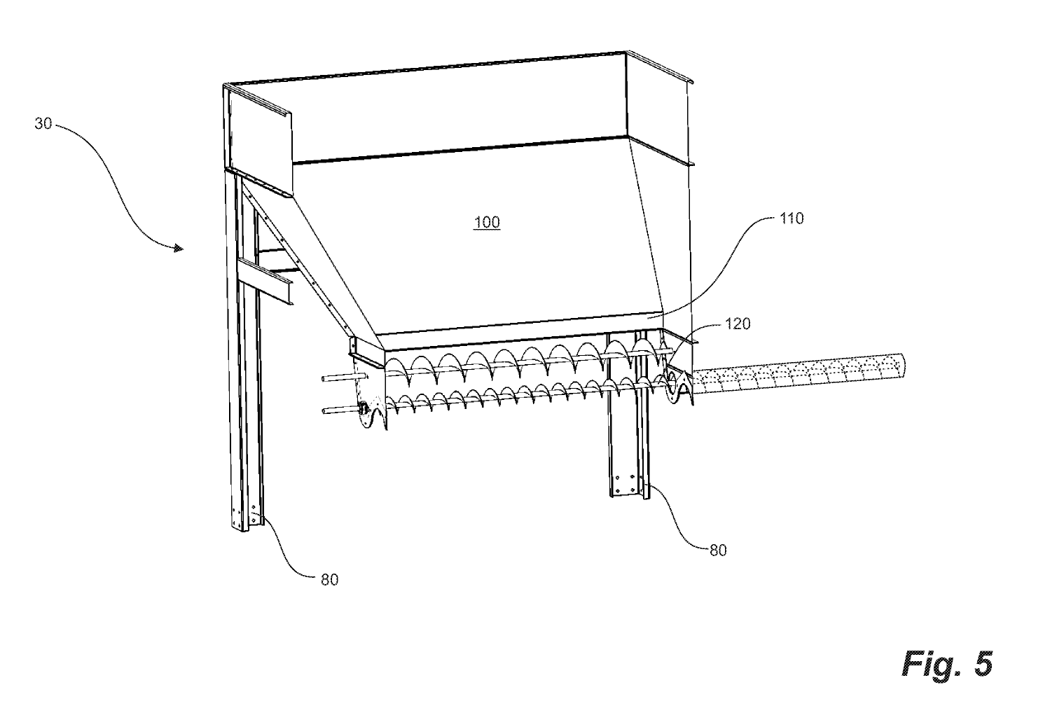

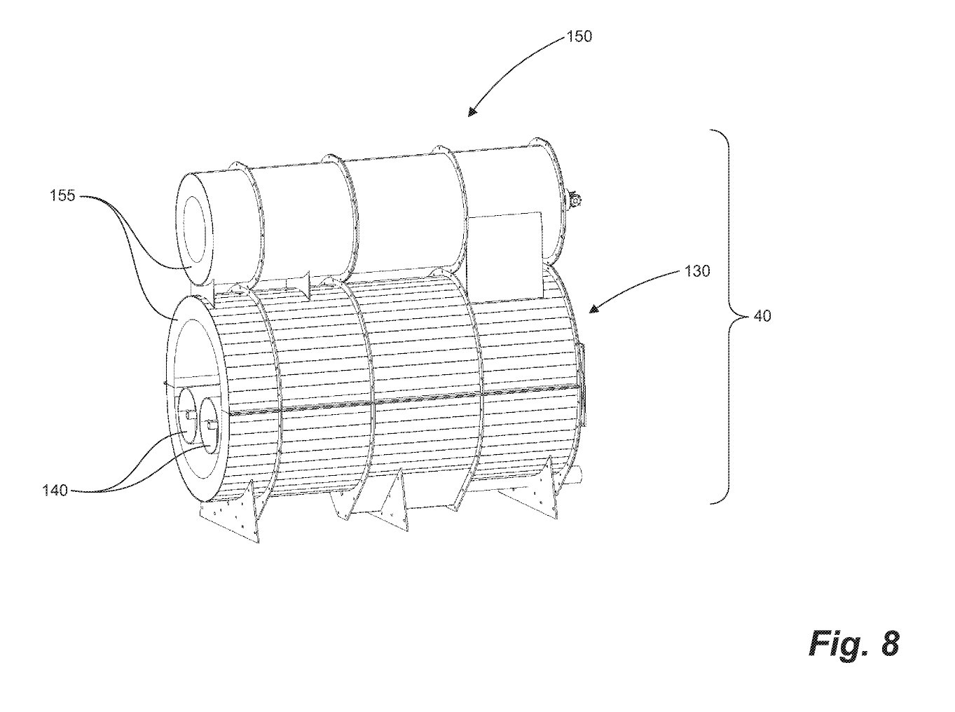

With reference to FIGS. 1 to 5, an embodiment of the hopper 30 may comprise a bin 70 supported on four legs 80, which has an open top 90 for receiving drill cuttings already blended with the anti-agglomerating material. The bin 70 can comprise tapered side walls 100 for downwardly directing the blended drill cuttings towards a bottom 110 of the bin, the bottom 100 having a screw type conveyor 120 for conveying the blended drill cuttings towards the combustor 40 (see FIGS. 5, 8 and 9A-D). As shown in the Figs., the hopper may comprise additional screw type conveyors that direct the drill cuttings to conveyor 120.

The embodiment of the hopper 30 shown in FIGS. 1 to 5 includes side walls 32, 32, a top wall 36 and an end wall 38 around the bottom of the hopper. The walls enclose the screw-type conveyor 120. Like walls 60, 62, 64 and 66, walls 32, 36 and 38 may be double-paneled, e.g., made of double-walled steel, to conserve heat and/or provide a space for insertion of insulation. In FIG. 2 a side wall 32 has been removed, to show that the interior of hopper 30 is open (at opening 34) to the interior of housing 68. The screw type conveyor is further located in housing 122 of the hopper, and runs through opening 34 towards furnace 130.

A screw-type conveyor, also known as an auger conveyor, uses a rotating helical screw blade to move liquid or granular materials. These types of conveyors are commonly disposed within a tube or a trough. Conveyor 120 can be used horizontally or at a slight incline or decline, to move the solid particulates towards the furnace 130.

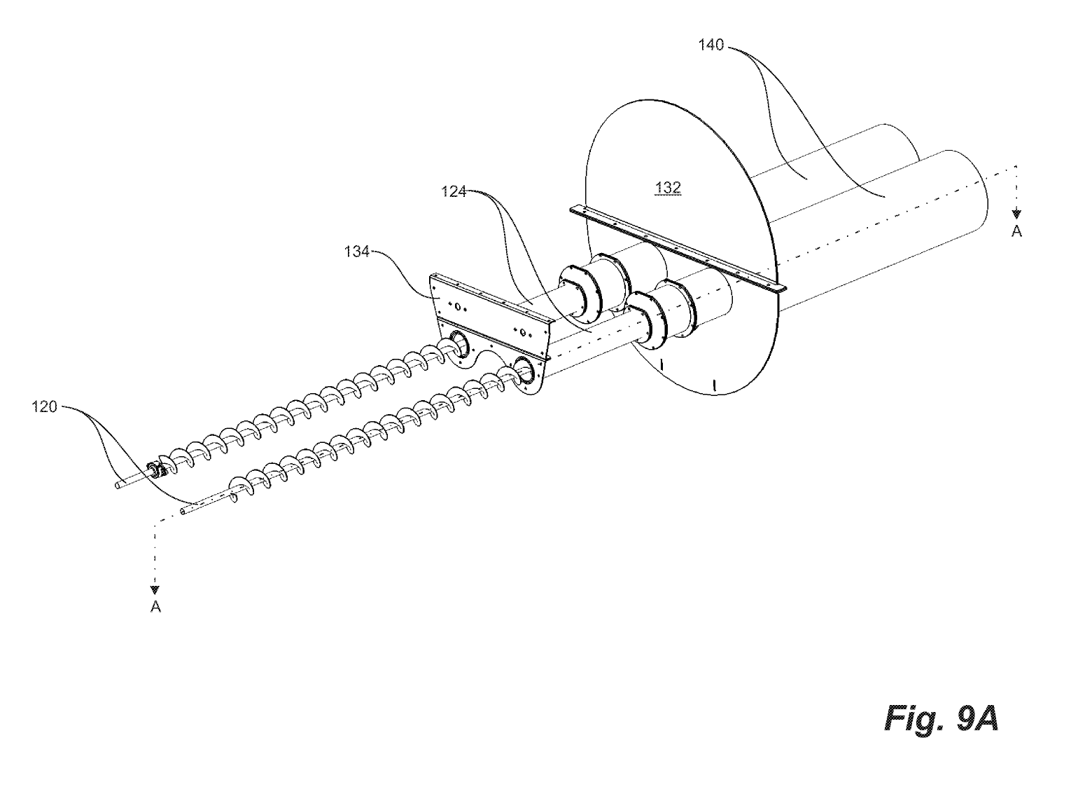

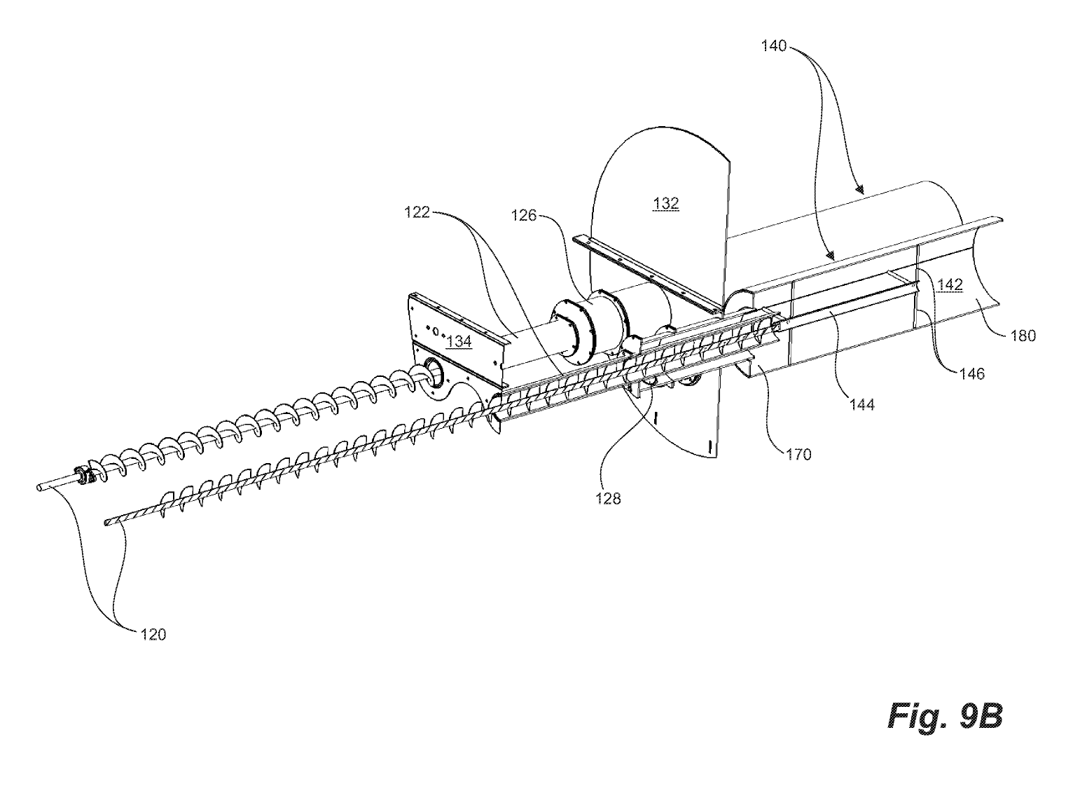

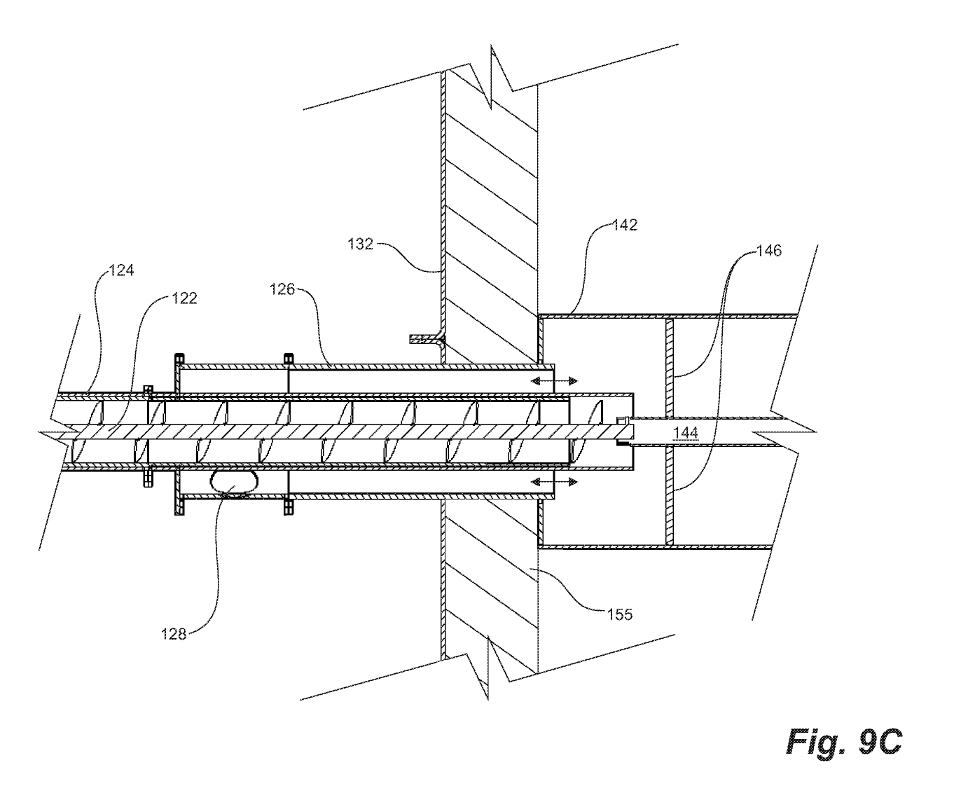

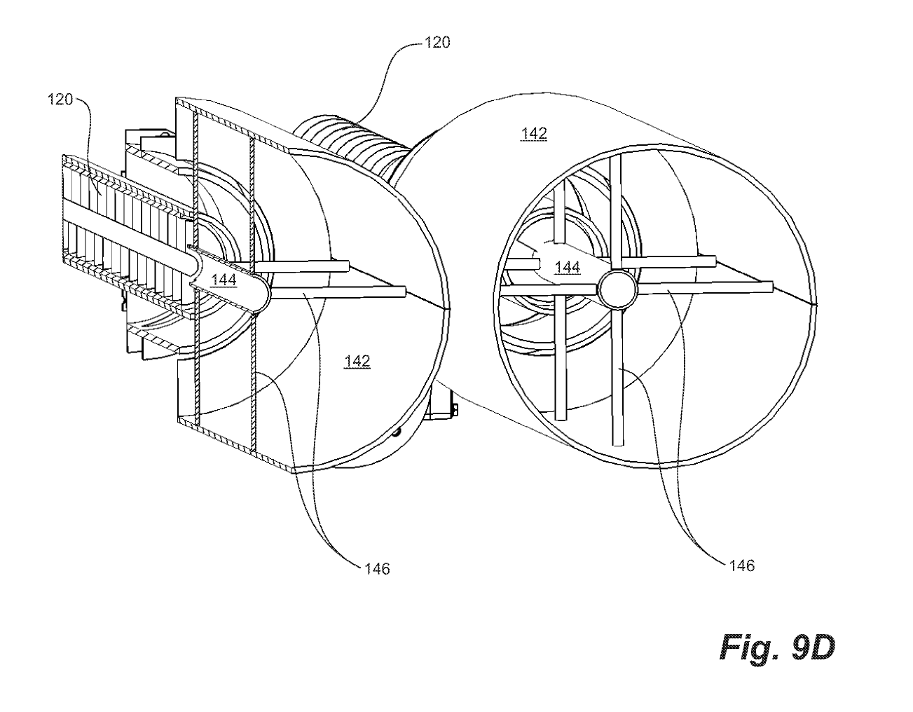

The embodiment of the hopper shown in the Figs. herein comprises two screw type conveyors that feed drill cuttings into the furnace 130. Other embodiments contemplate the use of only one conveyor 120, or of more than two conveyors 120. The screw-type conveyors may be made of a metal such as steel or a steel alloy, and need not be a high temperature steel or steel alloy. However in preferred embodiments the shaft is made of a high temperature steel or steel alloy, as the shaft may extend into the ECRV which is operating at very high temperatures (see e.g., FIG. 9C). Between the hopper and the furnace 130, the screw-type conveyor is housed in a conduit 124, such as a cylindrical pipe or tube made of steel or a steel alloy, which is used to transport the particulates therein. While shown as double-walled in the Figs. herein, conduit 124 need not be double-walled. As best shown in FIG. 9B or 9C, the shaft of conduit 124 of conveyor 120 extends into the feed end 142 of the exothermic continuous reaction vessel (ECRV) 140, where cuttings are then fed into the ECRV.

As best shown in FIGS. 9A to D, the apparatus may further comprise a means for delivering combustion air into the ECRV. In these embodiments, as conduit 124 approaches furnace 130, a housing (e.g., a tube) 126 is disposed around conduit 124, providing an air space between tubes 124 and 126 that is continuous with the inside space of the ECRV (see double-headed arrows in FIG. 9C). An opening 128 may be disposed in housing 126, through which combustion air may be blown into the ECRV (e.g., by a blower not shown). This air not only provides oxygen for combustion, but also cools conduit 124. Further, conduit 126 is insulated from the heat within the furnace by insulation layer 155.

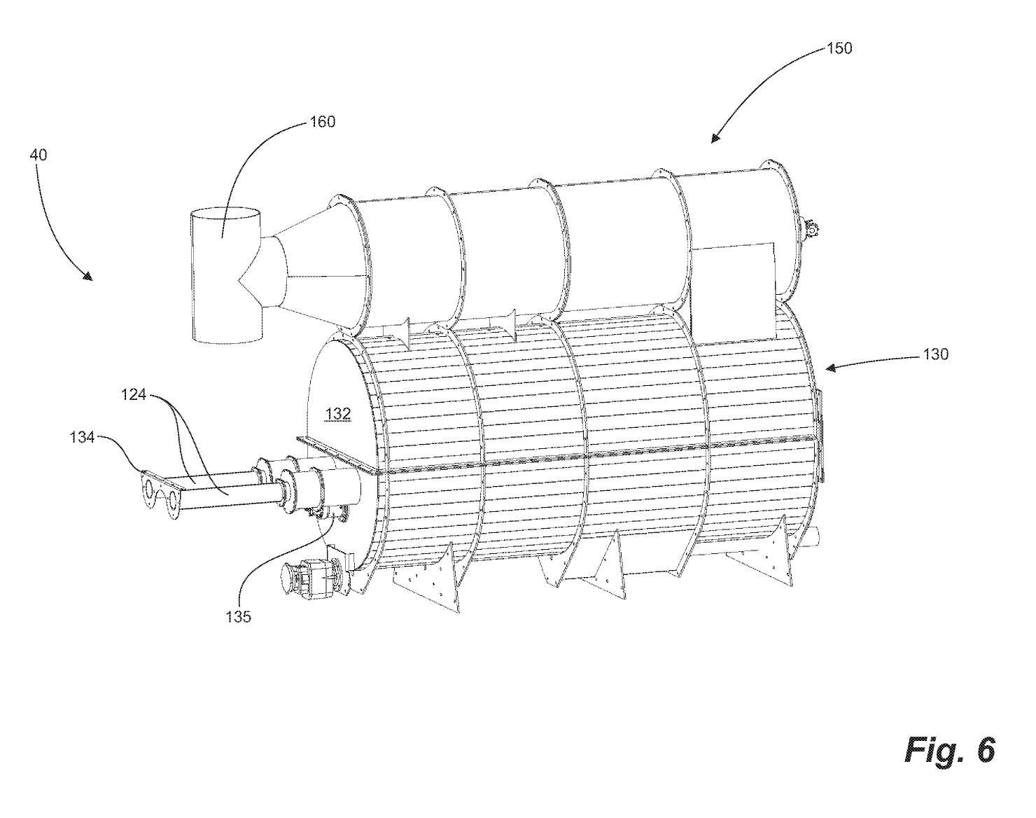

As shown in FIGS. 6 to 8, the combustor 40 comprises a furnace 130 which houses at least one exothermic continuous reaction vessel (“ECRV”) 140, and a secondary afterburner 150 which may have an exhaust stack 160. Preferably, both the furnace and the secondary afterburner are lined with insulation to retain heat in the combustor 40. Because of the temperatures used in this embodiment of the combustor, a ceramic fiber that can be used at up to 3,500° F. is preferred. The fiber liner is about 6″ thick. However, in other embodiments of system 10, depending on the application, insulating materials with a lower temperature value, and of different thicknesses, may be used.

As described above, the drill cuttings are conveyed from the hopper 30 to the ECRV, which is in essence, a rotating burn drum. The drill cuttings are disposed at a feed end 170 of the ECRV 140, and they are then combusted as they travel through the ECRV. The solid products of combustion exit the ECRV 140 at a discharge end 180, fall through an opening 190 at a bottom of the furnace 130, and are carried away from the system 10 by a screw type conveyor (not shown) which is disposed in a groove 195 within the opening 190. The gaseous products (exhaust) from the combustion of the drill cuttings exit the at least one ECRV 140 at the discharge end 180 and are directed into the secondary afterburner 150 for further treatment.

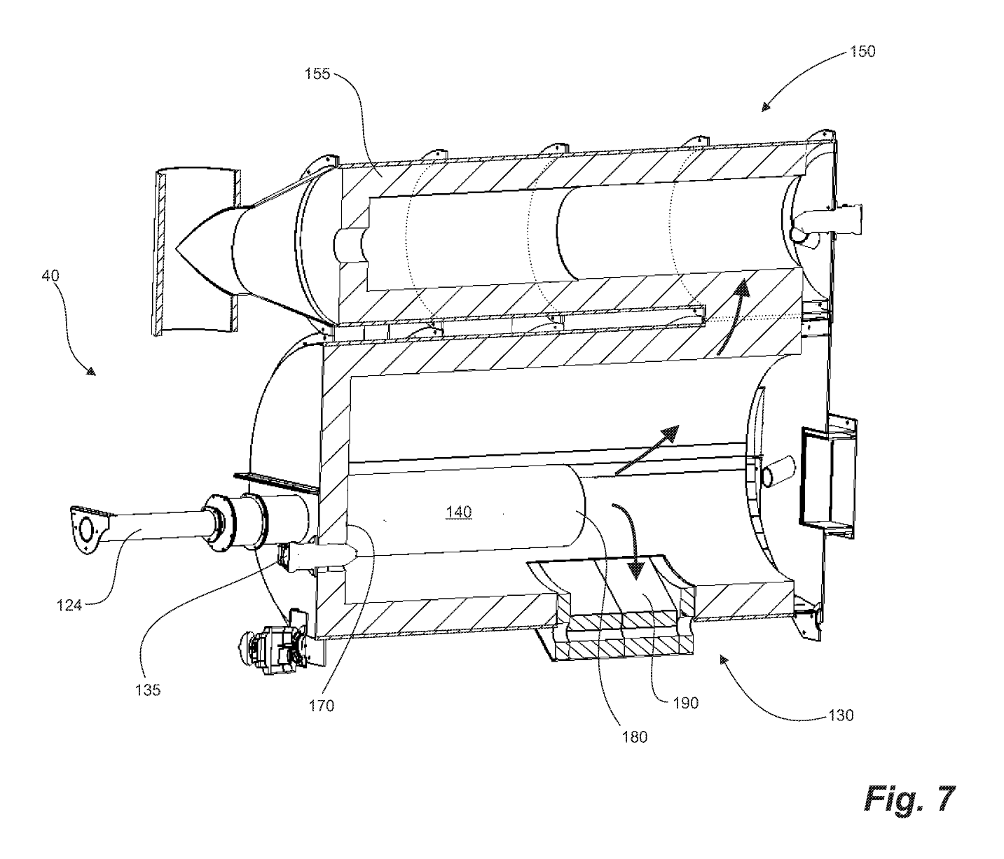

In an embodiment a burner 135, such as a propane burner (see FIGS. 6 and 7) is used to preheat the ECRV to a temperature that is sufficiently high to promote auto-ignition of the drill cuttings when they are disposed in the ECRV, or to heat the ECRV as needed if its temperature drops below the auto-ignition temperature. In the embodiment shown in FIGS. 6 and 7 the burner is situated between the two ECRVs.

The ECRV 140 is rotated to assist in preventing clumping or clinking of the blended drill cuttings, and thus assist in suspending the drill cuttings with the anti-agglomerating material, if used. The rotation of the ECRV further enhances and encourages complete combustion of the drill cuttings, by causing the blended drill cuttings to behave like a “fluid”, while flowing through the ECRV 140. The rotation of the ECRV 140 also assists in conveying the combustion products along the ECRV 140 from the feed end 170 towards the discharge end 180.

In the embodiments of the system 10 exemplified herein, and as best shown in FIG. 9D, the ECRV comprises a hollow drum 142, which may be cylindrical, attached to a shaft 144 by spokes 146. The ends of spokes 146 are welded to the drum and to the shaft. In preferred embodiments the drum 142, shaft 144 and spokes 146 are made of high temperature steel or other metal that can withstand high temperatures. Rotation of the ECRV is driven by rotation of the screw-type conveyor 120. As best seen in FIG. 9C, in one embodiment the interaction of a pin on the shaft of screw-type conveyor 120 with a slot on the shaft 144 of the ECRV connects shaft 120 and shaft 144. Therefore, the longitudinal axis of the screw-type conveyor 120 aligns with the longitudinal axis of the ECRV and these two components rotate in unison.

The shape and dimensions of the drum 42 may vary depending upon the type of particulate solid to be combusted in it. Thus for example it may be longer or shorter than depicted in the embodiments herein, to increase or decrease residence time, respectively, of the particulates within the ECRV. Or, it may have a larger or smaller diameter than is depicted in the Figs. herein, and it may be circular, oval, triangular, square, or some other geometrical shape, in cross section. Preferably it is round or oval in cross section. The drum is further selected to have a minimal weight, so as to reduce wear on the system, but to be sturdy enough to hold up to extreme operating conditions. In embodiments the wall of the drum is 3/16 or ¼ inches thick.

In the embodiments shown in the Figs. herein, the rotation of the screw-type conveyor 120 is driven by a motor (not shown). Therefore, the rotation of conveyor 120 drives the rotation of the ECRV.

In an embodiment, and with reference to the Figs. herein, the system 10, can comprise two ECRVs 140,140 for increasing the volume and amount of drill cuttings that can be treated. Accordingly, in such an embodiment, two screw type conveyors 120,120 can be operatively connected to the bottom 110 of the hopper bin 70 for transporting the drill cuttings from the hopper 30 to the ECRV 140. In embodiments the two conveyors 120 rotate in opposite directions.

In the embodiments of the system 10 for use in combusting drill cuttings, the ECRV operates at very high temperatures, for example up to about 1,200° F., and thus must be made of a material that can operate at these temperatures. In these embodiments, high temperature stainless steel alloys, such as 330 stainless steel or corten steel are preferred; however other metals or alloys that can withstand these temperatures may also be used. Depending on the types of particulate solids that are to be combusted in the ECRV, and therefore the temperature to which it may be subjected, the ECRV may be made of other metals. In embodiments the metal used has a melting point of up to 3000° F.

In embodiments the system 10, for combustion of drill cuttings, is designed to operate at a temperature of about 700° F. to about 800° F. in the furnace, as measured by a temperature sensor located inside the furnace. A thermometer for measuring the temperature inside the furnace 130 may be situated on a side wall of the furnace towards the front of the furnace (e.g., at about the tip of the arrow pointing upwards from the ECRV in FIG. 7). In these embodiments the secondary afterburner 150 may operate at a temperature of about 1800° F. The temperature inside the furnace and/or secondary afterburner may be different in other embodiments, depending on the types of particulate solids that are to be combusted in the ECRV.

Exhaust from the combustion of the blended drill cuttings exits the ECRV 140 and is directed into the secondary afterburner 150. Therein, and in an embodiment, the exhaust can be induced into a vortex spiral motion to increase residency time of the exhaust within the secondary afterburner 150. Thus, in one embodiment the opening into the secondary afterburner is offset to one side, so that the exhaust enters the afterburner along a curved edge and is induced into a spiral. In the afterburner 150, the exhaust is ignited or combusted with the addition of a supplementary fuel source, such as propane or natural gas. In embodiments, the supplementary fuel source can be onsite fuel from the well or in another embodiment can be piped in.

Once the exhaust is combusted or treated, the final gaseous products can be expelled, vented or otherwise exhausted from the system 10 through the exhaust stack 160.

In an embodiment, SOₓ products within the exhaust of the blended drill cuttings can be scrubbed therefrom, using methods known to those of skill in the art. One method of scrubbing is by the addition of limestone during the secondary burning or combustion of the exhaust.

Further still, in another embodiment, NOₓ products can also be scrubbed with the addition of NOₓ adsorption systems using methods known to those of skill in the art.

### In Operation

With reference to FIGS. 6 to 8, the ECRV 140 is preheated to about 1100° F. (temperature for auto-ignition of the blended drill cuttings). The drill cuttings from shale and/or cardium sandstone rock are prepared for introduction into the system 10, and more particularly into the hopper 30, by blending them with an anti-agglomerating material, such as saw dust or small wood chips, to help ensure uniformity of treatment. Pre-heating of the ECRV 140 can be accomplished using methods known in the industry. One such method can include using a burner 135 placed underneath the ECRV 140 and ignited for pre-heating the ECRV.

The blended drill cuttings are then conveyed from the hopper 30 to the ECRV 140 housed within the furnace 30, for combustion or treatment. One means of conveying the blended drill cuttings is by a screw-type conveyor 120 situated at the bottom of the hopper, and extending to the ECRV 140. Combustion air is also directed into the ECRV.

As the blended drill cuttings enter the ECRV 140 at the feed end 170, the pre-heated ECRV 140 causes the near immediate auto-ignition or combustion of the hydrocarbons within the blended drill cuttings. The ECRV 140 is rotated by the conveyor 120, to assist in suspending the drill cuttings, and to provide impetus for moving the reactants (blended drill cuttings) and solid combustion products (treated drill cuttings) through the ECRV 140 and towards the discharge end 180.

In an embodiment, the temperature of the ECRV 140 can be controlled by an automated electronic control. Further, as combustion of the blended drill cuttings provides heat, heating of the ECRV 140 can be self-sustaining or self-propagating, only requiring supplementary fuel, such as propane, when the temperature of the ECRV 140 falls sufficiently below a threshold temperature such that the blended drill cuttings cannot auto-ignite when entering into the feed end 170 of the ECRV 140.

The solid treated drill cuttings continue through the ECRV 140 and are removed therefrom by falling out of the discharge end 180 thereof, continuing through an opening 190 at the bottom of the furnace 130 and onto a screw conveyor (not shown) for removal from the system 10.

In an embodiment, the treated cuttings removed by the screw conveyor can be further treated by a water rinse module or calcium amending blending modules to achieve specific sodium adsorption ratios.

The exhaust from the combustion of the blended drill cuttings exits the discharge end 180 and is directed into the secondary afterburner 150 for further treatment. In an embodiment, the exhaust can be induced into a vortex spiral for increasing the residency time therein, and is further combusted with the addition of a supplemental fuel, such as propane or natural gas from a burner associated with the secondary afterburner. The gaseous products from the combustion of the exhaust can then be expelled, vented, or otherwise exhausted into the atmosphere through the exhaust stack 160.

As described above, in an embodiment, the exhaust can be treated with a SOₓ scrubbing system, such as with reactants such as limestone to scrub SOₓ and/or treated with a NOₓ adsorption system to remove NOₓ.

While the method and apparatus have been described in conjunction with the disclosed embodiments which are set forth in detail, it should be understood that this is by illustration only and the method and apparatus are not intended to be limited to these embodiments. On the contrary, this disclosure is intended to cover alternatives, modifications, and equivalents which will become apparent to those skilled in the art in view of this disclosure.

1. A system for combusting particulate solids comprising:
a) a hopper, a furnace and a secondary afterburner;
b) said furnace further comprising at least one exothermic continuous reaction vessel (ECRV), said ECRV having a volume that is smaller than the volume of the furnace, and said ECRV further having a receiving end and a disposal end within the furnace;
c) at least one conduit extending from the hopper to the receiving end of the at least one ECRV, and
d) a rotating conveyor inside the at least one conduit, for conveying the particulate solids from the hopper into the ECRV,
e) said rotating conveyor being connected to the at least one ECRV, such that the ECRV will rotate with the rotating conveyor.

2. The system of claim 1 wherein the disposal end of the ECRV is above an opening in the furnace through which particulate solids can be removed from the furnace.

3. The system of claim 1, wherein the rotating conveyor is a screw type conveyor.

4. The system of claim 3, wherein the ECRV is a hollow cylinder.

5. The system of claim 4 wherein the ECRV is comprised of high temperature steel.

6. The system of claim 6, wherein the axis of rotation of the ECRV aligns with the axis of rotation of the conveyor.

7. The system of claim 1, further comprising an opening between the furnace and the secondary afterburner through which exhaust exiting the disposal end of the ECRV can enter the secondary afterburner.

8. The system of claim 1, wherein the rotation of the rotating conveyor drives the rotation of the ECRV.

9. The system of claim 1, wherein the volume of the ECRV is less than about 25% of the volume of the furnace.

10. The system of claim 1 further comprising a heater that heats the at least one ECRV.

11. A method of combusting solid particulates comprising:
a) delivering the solid particulates from a hopper to a rotating exothermic continuous reaction vessel (ECRV) inside a furnace, said ECRV having a volume that is substantially less than the volume of the furnace;
b) combusting the solid particulates within the ECRV while the ECRV is rotating at the auto-ignition temperature of the solid particulates.
c) expelling the solid particulates from the ECRV into the furnace; and
d) collecting the solid particulates from the furnace.

12. The method of claim 11 further comprising heating the ECRV to the auto-ignition temperature before delivering the solid particulates from the hopper to the rotating ECRV.

13. The method of claim 11, wherein the volume of the ECRV is less than about 25% of the volume of the furnace.

14. The method of claim 12, wherein the volume of the ECRV is less than about 25% of the volume of the furnace.

15. The method of claim 13 further comprising delivering the solid particulates from the hopper to the ECRV with a screw type conveyor which removes the solid particulates from the hopper and delivers them along a conduit towards the ECRV.

16. The method of claim 14 further comprising delivering the solid particulates from the hopper to the ECRV with a screw type conveyor which removes the solid particulates from the hopper and delivers them along a conduit towards the ECRV.

17. The method of claim 16 wherein the rotation of the screw type conveyor drives the rotation of the ECRV.

18. The method of claim 17 wherein the axis of rotation of the ECRV aligns with the axis of rotation of the conveyor.

19. The method of claim 13 further comprising combusting an exhaust from the ECRV in a secondary afterburner.
